(19) United States
(12) Patent Application Publication
(10) Pub. No.: US 2005/0289565 A1
(43) Pub. Date: Dec. 29, 2005

(54) Optical disc drive and the mecha thereof

(76) Inventors: Shan-Yen Yang, Taoyuan City (TW); Jian-Bo Gu, Lianyun Kang City (CN); Ji-Wei Wang, Nanjing City (CN)

Correspondence Address: RABIN & BERDO, P.C., Suite 500, 1101 14th Street, N.W., Washington, DC, 20005, US

(21) Appl. No.: 11/166,078

(22) Filed: Jun. 27, 2005

(30) Foreign Application Priority Data
Jun. 29, 2004 (TW) 93119170

(51) Int. Cl. G11B 17/03

(52) U.S. Cl. 720/600

(57) ABSTRACT

An optical/mechanical applied to a disc drive includes a spindle motor, a base plate, a principal guiding bar, and an optical pickup head. The spindle motor and the principal guiding bar are disposed on the base plate. The optical pickup head is movably disposed on the principal guiding bar and shifts along the axial direction of the principal guiding bar.

This application claims the benefit of Taiwan application Serial No. 93119170, filed Jun. 29, 2004, the subject matter of which is incorporated herein by reference.

### BACKGROUND OF THE INVENTION

1. Field of the Invention

The invention relates in general to an optical disc drive, and more particularly to a mecha of the optical disc drive.

2. Description of the Related Art

The hardware structure of an optical disc drive mainly comprises a mecha and an electric control module. The main function of the mecha is to rotate an optical disc and generate light spots to access data from the optical disc. The constituting element of the mecha comprises a spindle motor for driving an optical disc to rotate, and an optical pickup head for generating light spots to access data from the optical disc.

Referring to both FIG. 1 and FIG. 2, wherein FIG. 1 is a decomposition diagram of a conventional mecha in an optical disc drive, while FIG. 2 is an assembly diagram of a mecha in FIG. 1. Conventional mecha 100 in an optical disc drive mainly comprises a mounting plate 102, a spindle motor base-plate 104, a spindle motor 106, a principal guiding bar 108 and an optical pickup head 110.

The first principal guiding bar base unit 112a and the second principal guiding bar base unit 112b are respectively locked onto the two sides of the mounting plate 102 via the first locking screw 114a and the second locking screw 114b. The principal guiding bar 108 is disposed on the mounting plate 102 by using the first principal guiding bar base unit 112a and the second principal guiding bar base unit 112b to respectively receive and fix the first bar end 116a and the second bar end 116b of the principal guiding bar 108.

The optical pickup head 110 is moveably disposed on the principal guiding bar 108 and shifts along the axial direction of the principal guiding bar 108. For example, the axle sleeve 118, which is fixed onto the optical pickup head 110, receives the principal guiding bar 108, so that the optical pickup head 110 shifts along the axial direction of the principal guiding bar 108 via the axle sleeve 118. Besides, the mounting plate 102 has a secondary guiding bar 120 disposed thereon, wherein the secondary guiding bar 120 is for supporting the optical pickup head 110 in movement, so that the optical pickup head 110 keeps stable when accessing data from the rotating optical disc driven by the spindle motor 106.

On the other hand, the spindle motor base-plate 104 is locked onto the mounting plate 102 via the first locking element set 122a and the second locking element set 122b, and the spindle motor 106 is disposed on the spindle motor base-plate 104.

Generally speaking, how good the mecha of an optical disc drive recognizes an optical disc is an important index showing the quality of an optical disc drive. As shown in FIG. 2, Y1, the distance from the rotation center of the spindle motor 106 to the axis of the principal guiding bar 108, is exactly a key factor affecting the capability of accessing an optical disc by the mecha 100, and more particularly, a key factor with regards to the ability of recognizing an offset optical disc.

In the above conventional mecha 100, assembly tolerance respectively exists between the spindle motor base-plate 104 and the mounting plate 102, and between the spindle motor 106 and the spindle motor base-plate 104. Besides, assembly tolerance also exist between the mounting plate 102 and the first principal guiding bar base unit 112a as well as the second principal guiding bar base unit 112b, and between the principal guiding bar 108 and the first principal guiding bar base unit 112a as well as the second principal guiding bar base unit 112b. Moreover, the above elements have their own manufacturing tolerance as well.

Therefore, Y1, the distance from the rotation center of the spindle motor 106 to the axis of the principal guiding bar 108, would accumulate considerable amount of tolerance, and deviate from the design value considerably, causing the mecha 100 to fail to access the optical disc and hindering the improvement of the quality of the optical disc drive.

### SUMMARY OF THE INVENTION

It is therefore an object of the invention to provide an mecha of an optical disc drive, whose distance from the rotation center of the spindle motor to the axis of the principal guiding bar better complies with the designed value, enhancing the mecha to have a better ability of accessing optical disc, hence improving the quality and efficiency of the optical disc drive.

According to the above object, the invention provides a mecha of a disc drive, comprising a spindle motor, a base plate, a principal guiding bar, and an optical pickup head. The spindle motor and the principal guiding bar are disposed on the base plate. The optical pickup head is movably disposed on the principal guiding bar and shifts along the axial direction of the principal guiding bar. The mecha of the invention further comprises a mounting plate on which the spindle motor base-plate is disposed.

Moreover, in the mecha of the invention, the principal guiding bar has a first bar end and a second bar end, while the spindle motor base-plate can comprise a first supporting portion and a second supporting portion. The first supporting portion and the second supporting portion are respectively opposite to the first bar end and the second bar end. The first supporting portion has a first indention, while the second supporting portion has a second indention. The first indention and the second indention respectively receive and fix a first bar end and a second bar end, so that the principal guiding bar are disposed on the spindle motor base-plate.

In the mecha of the invention, the first supporting portion and the second supporting portion respectively can be a first protrusion pair and a second protrusion pair, or a first bearer and a second bearer. The pair of first protrusions and the pair of second protrusions can respectively be formed in one block on the spindle motor base-plate. Besides, the first bearer and the second bearer respectively can have a formed-in-one-block structure, or respectively ca be formed on the spindle motor base-plate through ejection.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a decomposition diagram of a conventional mecha in an optical disc drive;

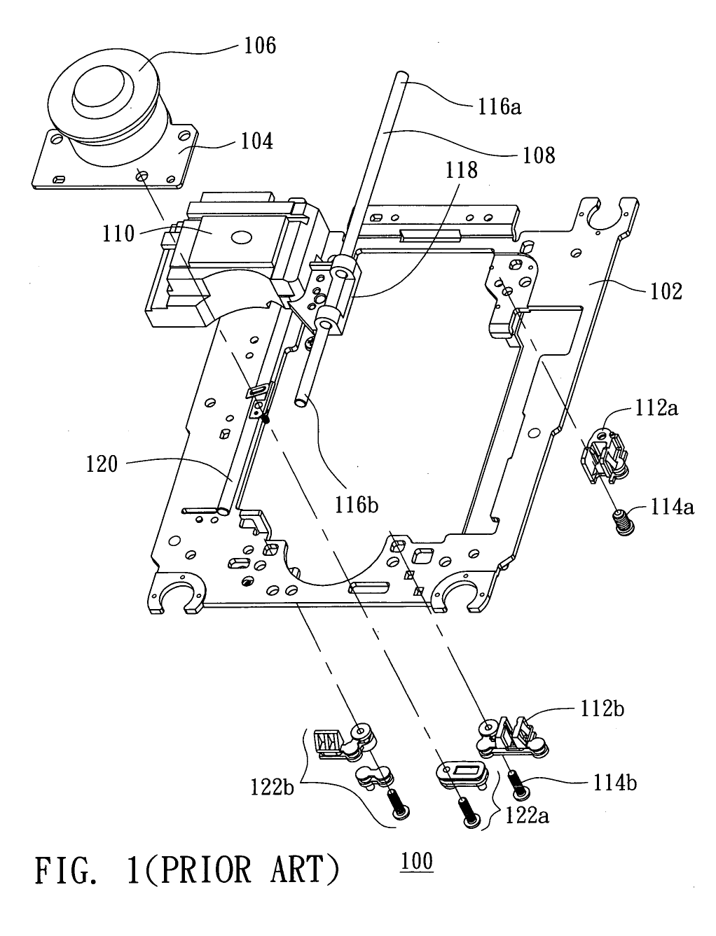

FIG. 2 is an assembly diagram of an mecha in FIG. 1;

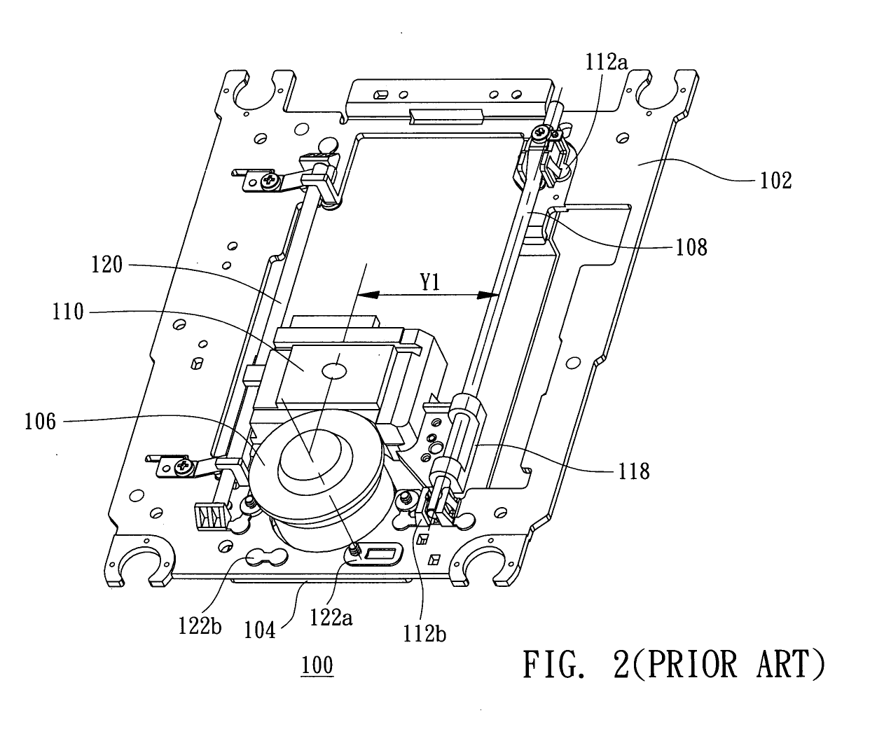

FIG. 3 is a schematic diagram of an mecha of an optical disc drive according to a preferred embodiment of the invention;

FIG. 4A is a decomposition diagram of a spindle motor and a principal guiding bar of an mecha in FIG. 3;

FIG. 4B is an assembly diagram of FIG. 4A; and

FIG. 5 is another schematic diagram of a bearer disposed on a spindle motor base-plate for fixing the principal guiding bar.

### DETAILED DESCRIPTION OF THE INVENTION

Despite the invention is exemplified by a preferred embodiment, the scope of protection of the invention is not limited thereto. The embodiment is a mecha of an optical disc drive according to the spirit of the invention. The characteristics of technology of the invention are disclosed herein.

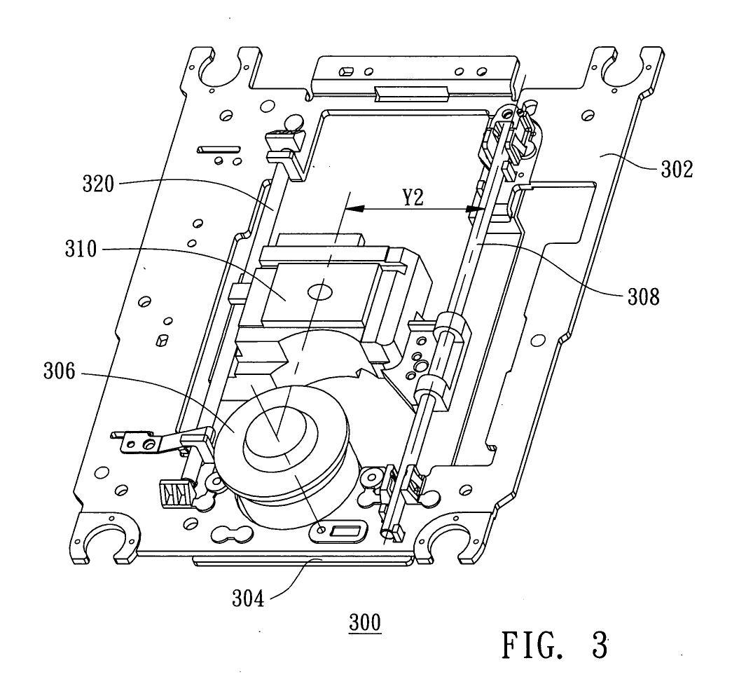

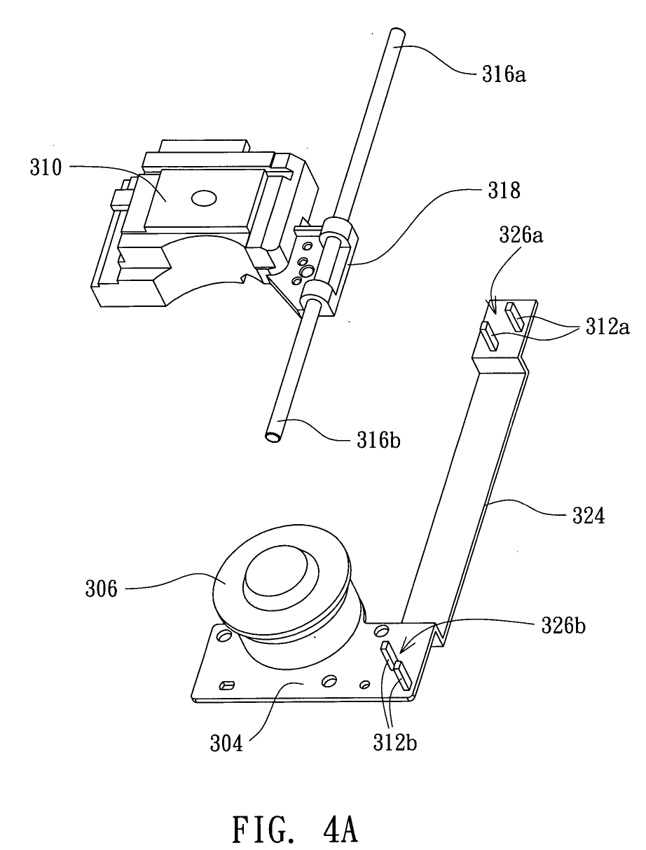

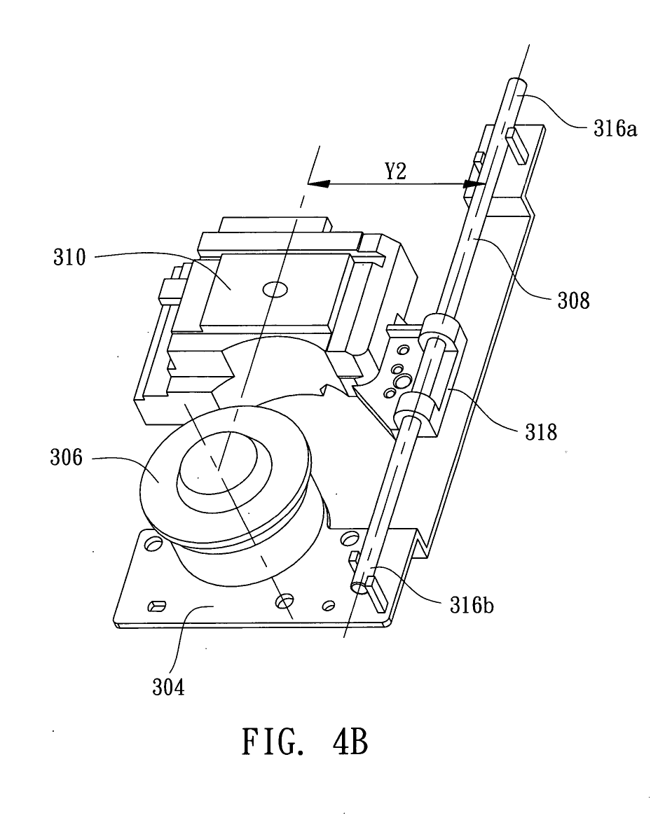

Referring to FIG. 3, FIG. 4A and FIG. 4B. FIG. 3 a schematic diagram of a mecha of an optical disc drive according to a preferred embodiment of the invention. FIG. 4A is a decomposition diagram of a spindle motor and a principal guiding bar of a mecha in FIG. 3. FIG. 4B is an assembly diagram of FIG. 4A. Mecha 300 of the optical disc drive of the invention mainly comprises a mounting plate 302, a spindle motor base-plate 304, a spindle motor 306, a principal guiding bar 308 and an optical pickup head 310.

Referring to both FIG. 4A and FIG. 4B. The spindle motor 306 is disposed on the spindle motor base-plate 304. The spindle motor base-plate 304 is coupled to the spindle motor 306 and has an extension portion 324. The spindle motor base-plate 304 comprises a first supporting portion and a second supporting portion, which can be a pair of first protrusions 312a and a pair of second protrusions 312b for instance. The paired first protrusions 312a and the paired second protrusions 312b are respectively disposed on the two sides of the extension portion 324 of the spindle motor base-plate 304. The paired first protrusions 312a have a first indention 326a, while the paired second protrusions 312b have a second indention 326b.

The principal guiding bar 308 has a first bar end 316a and a second bar end 316b The paired first protrusions 312a and the paired second protrusions 312b disclosed above are respectively opposite to the first bar end 316a and the second bar end 316b. The first indention 326a and the second indention 326b respectively receive and fix the first bar end 316a and the second bar end 316b, so that the principal guiding bar 308 is disposed on the extension portion 324 of the spindle motor base-plate 304.

Moreover, the optical pickup head 310 is moveably disposed on the principal guiding bar 308 and shifts along the axial direction of the principal guiding bar 308. For example, an axle sleeve 318 is fixed onto the optical pickup head 310. Through receiving the principal guiding bar 308 by the axle sleeve 318, the optical pickup head 310 shifts along the axial direction of the principal guiding bar 308 via the axle sleeve 318.

Besides, refer to FIG. 3 at the same time. The mounting plate 302 has a secondary guiding bar 320 disposed thereon for supporting the optical pickup head 310 in movement, so that the optical pickup head 310 keeps stable when accessing data from the rotating optical disc driven by the spindle motor 306. Lastly, the spindle motor base-plate 304 having a principal guiding bar 308 and a spindle motor 306 disposed thereon is disposed on the mounting plate 302 and becomes the mecha 300 as shown in FIG. 3. Moreover, the mecha 300 can be incorporated together with the body of the optical disc drive via the mounting plate 302 to form an optical disc drive. That is to say, the mounting plate 302 is disposed on the body of an optical disc drive to form an optical disc drive.

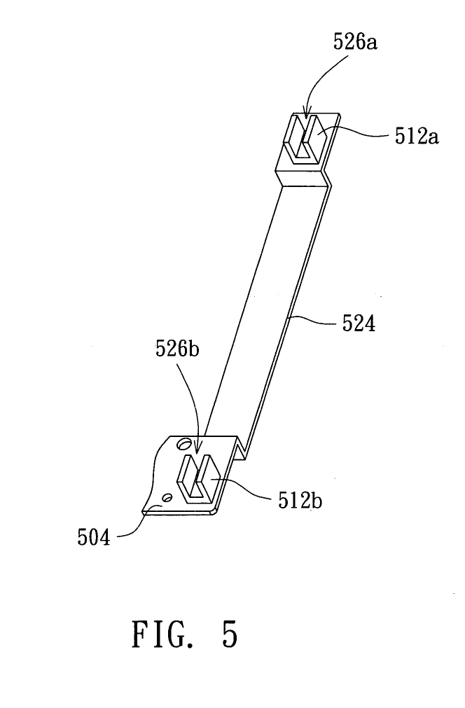

Referring to FIG. 5, another schematic diagram of a bearer disposed on a spindle motor base-plate for fixing the principal guiding bar is shown. The diagram illustrates an extension portion 524 of a spindle motor base-plate 504. Apart from the paired first protrusions 312a and the paired second protrusions 312b disclosed in above embodiment, the element disposed on the spindle motor base-plate for fixing the elements of the principal guiding bar can be implemented according to the method disclosed below.

The spindle motor base-plate 504 comprises a first supporting portion and a second supporting portion, which can be a first bearer 512a and a second bearer 512b for instance. The first bearer 512a and the second bearer 512b are respectively disposed on the two sides of the extension portion 524 of the spindle motor base-plate 504. The first bearer 512a has a first indention 526a, while the second bearer 512b has a second indention 526b.

The first bearer 512a and the second bearer 512b are respectively opposite to the first bar end 316a and the second bar end 316b of the principal guiding bar 308 in FIG. 4A. The first indention 526a and the second indention 526b respectively receive and fix the first bar end 316a and the second bar end 316b in FIG. 4A, so that the principal guiding bar 308 is disposed on the extension portion 524 of the spindle motor base-plate 504.

Moreover, in FIG. 4A, the paired first protrusions 312a and the paired second protrusions 312b are respectively formed in one block on the extension portion 324 of the spindle motor base-plate 304. In FIG. 5, the first bearer 512a and the second bearer 512b respectively have a formed-in-one-block structure. Besides, the first bearer 512a and the second bearer 512b can be respectively formed on the extension portion 524 of the spindle motor base-plate 504 through ejection.

It can be understood from the above embodiment that both the principal guiding bar 308 and the spindle motor 306 are disposed on the spindle motor base-plate 304 in the mecha 300 of the optical disc drive of the invention, while the principal guiding bar 108 and the spindle motor 106 are respectively disposed on the mounting plate 102 and the spindle motor base-plate 104 in the conventional mecha 100.

Therefore, Y2, the distance from the rotation center of the spindle motor 306 to the axis of the principal guiding bar 308, would only accumulate the assembly tolerance between the spindle motor 306 and the spindle motor base-plate 304, the assembly tolerance between the spindle motor base-plate 304 and the paired first protrusions 312a as well as the paired second protrusions 312b (or the assembly tolerance between the spindle motor base-plate 504 and the first bearer 512a as well as the second bearer 512b), and the assembly tolerance between the principal guiding bar 308 and the paired first protrusions 312a as well as the paired second protrusions 312b (or between the principal guiding bar 308 and the first bearer 512a as well as the second bearer 512b). Moreover, the manufacturing tolerance of above elements accumulates, while the assembly tolerance between the spindle motor base-plate 304 and the mounting plate 302 and the manufacturing tolerance of the mounting plate 302 are eliminated.

Given that the paired first protrusions 312a and the paired second protrusions 312b are respectively formed in one block on the extension portion 324 of the spindle motor base-plate 304, or that the first bearer 512a and the second bearer 512b are respectively formed on the extension portion 524 of the spindle motor base-plate 504 through ejection, the assembly precision is higher, largely reducing the assembly tolerance between the spindle motor base-plate 304 and the paired first protrusions 312a as well as the paired second protrusions 312b or between the spindle motor base-plate 304 and the paired first bearers 512a as well as the second bearer 512b.

For the mecha 300 of the optical disc drive of the invention, Y2, the distance from the rotation center of the spindle motor 306 to the axis of the principal guiding bar 308, would accumulate less tolerance and is less deviated from the design value, enhancing the capability of accessing optical disc by the mecha 300, hence improving the quality and efficiency of the optical disc drive.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An mecha of an optical disc drive, comprising at least:
a spindle motor base-plate;
a spindle motor disposed on the spindle motor base-plate;
a principal guiding bar disposed on the spindle motor base-plate; and
an optical pickup head, which is moveably disposed on the principal guiding bar and shifts along the shift of the principal guiding bar.

2. The mecha according to claim 1, wherein the mecha further comprises a mounting plate, while the spindle motor base-plate is disposed on the mounting plate.

3. The mecha according to claim 1, wherein the principal guiding bar has a first bar end and a second bar end, while the spindle motor base-plate comprises:
a first supporting portion, which is opposite to the first bar end and has a first indention; and
a second supporting portion, which is opposite to the second bar end and has a second indention, wherein the first indention and the second indention respectively receive and fix the first bar end and the second bar end, so that the principal guiding bar is disposed on the spindle motor base-plate.

4. The mecha according to claim 3, wherein the first supporting portion is a pair of first protrusions, the second supporting portion is a pair of second protrusions, and the pair of first protrusions and the pair of second protrusions are respectively formed in one block on the spindle motor base-plate.

5. The mecha according to claim 3, wherein the first supporting portion is a first bearer, the second supporting portion is a second bearer, and both the first bearer and the second bearer have a formed-in-one-block structure.

6. The mecha according to claim 3, wherein the first bearer and the second bearer respectively are formed on the spindle motor base-plate through ejection.

7. An optical disc drive, comprising at least:
a mounting plate;
a spindle motor base-plate disposed on the mounting plate;
a first supporting portion disposed on the spindle motor base-plate;
a second supporting portion disposed on the spindle motor base-plate;
a spindle motor disposed on the spindle motor base-plate;
a principal guiding bar having a first bar end and a second bar end, wherein the first supporting portion and the second supporting portion respectively support and fix the first bar end and the second bar end, so that the principal guiding bar is disposed on the spindle motor base-plate; and
an optical pickup head moveably disposed on the principal guiding bar and shifting along the axial direction of the principal guiding bar.

8. The optical disc drive according to claim 7, wherein the first supporting portion is a pair of first protrusions, the second supporting portion is a pair of second protrusions, and the pair of first protrusions and the pair of second protrusions are respectively formed in one block on the spindle motor base-plate.

9. The optical disc drive according to claim 7, wherein the first supporting portion is a first bearer, the second supporting portion is a second bearer, and the first bearer and the second bearer respectively have a formed-in-one-block structure.

10. The optical disc drive according to claim 7, wherein the first bearer and the second bearer respectively are formed on the spindle motor base-plate through ejection.
